(19) United States
(12) Patent Application Publication
(10) Pub. No.: US 2024/0257331 A1
(43) Pub. Date: Aug. 1, 2024

(54) SYSTEM FOR ASSESSING THE QUALITY OF A PHYSICAL OBJECT

(71) Applicant: BASF SE, Ludwigshafen Am Rhein (DE)

(72) Inventors: Ali Bina, Duesseldorf (DE); Mario Ramos Da Silva Junior, Ludwigshafen am Rhein (DE); Tobias Reichel, Lemfoerde (DE); Lisa Marie Schmidt, Lemfoerde (DE); Hergen Schultze, Ludwigshafen am Rhein (DE); Matthias Goldbeck, Muenster (DE); Benjamin Chikhi, Lemfoerde (DE); Rainer Friehmelt, Ludwigshafen am Rhein (DE); Patrick Graefen, Ludwigshafen am Rhein (DE); Juergen Ettmueller, Ludwigshafen am Rhein (DE)

(21) Appl. No.: 18/578,474

(22) PCT Filed: Jul. 13, 2022
(86) PCT No.: PCT/EP2022/069615

§ 371 Date: Jan. 11, 2024

(30) Foreign Application Priority Data
Jul. 14, 2021 (EP) 21185517.6

(51) Int. Cl. G06T 7/00; G06T 7/11

(52) U.S. Cl. CPC G06T 7/0004; G06T 7/11; G06T 2207/10152; G06T 2207/20081; G06T 2207/20084; G06T 2207/30164

(57) ABSTRACT

The invention refers to a system (100) for assessing the quality of a physical product (111). A device (110) provides visual image data of the product and comprises a) a lighting setup comprising a lighting device (112) adapted for lighting the product and b) a camera (113) adapted for detecting light from the lighting device to generate visual image data of the product based on the detected light. An apparatus (120) assesses the quality of the product and comprises a) a providing unit (121) adapted to provide a trained machine learning based assessment model, wherein the model has been trained based on historical visual image data, and wherein the trained assessment model is adapted to determine a quality of the product, and b) an assessment unit (123) adapted to assess a quality of the product by applying the trained assessment model to the visual image data.

### FIELD OF THE INVENTION

The invention relates to a quality assessment system for assessing a quality of a physical object, a visual inspection device and a quality assessment apparatus being utilizable in the quality assessment system. Further, the invention relates to an assessment model training apparatus for training an assessment model being utilizable in the quality assessment system, an assessment model training method, and a computer program product for training the assessment model. Moreover, the invention relates to a quality assessment method for assessing a quality of a physical product and a computer program product for assessing a quality of a physical product.

### BACKGROUND OF THE INVENTION

It is generally known that in an industrial production of a physical product, errors and failures can occur that might lead to a loss of quality of a respective production line. In particular, in complex chemical production processes already slight differences in production parameters, like reactor temperature, can lead to differences in the final product. Some of these differences might be acceptable, although they lead to differences to the optimal product, whereas some of these differences are not acceptable. For assessing such quality differences in a physical product and, in particular, to prevent the release of final products with a not acceptable quality, it is common to retrieve production samples from each production line and to visually assess the quality. In particular, human specialists are trained to recognize, identify and optionally classify differences in the test product from the optimal state and to assess the quality of the final product based on these differences. However, this process is not only cumbersome and work-intensive, but also prone to human inaccuracies. For example, it is very likely that each quality assessment specialist applies a slightly different classification and assessment scheme such that the final outcome of the quality assessment depends on the individual specialist having performed the quality assessment.

It would thus be advantageous to provide a system that allows to decrease the influence of human assessment as much as possible and thus allows for an objective and reproducible quality assessment of a physical object.

### SUMMARY OF THE INVENTION

It is an object of the present invention to provide a system that allows for an objective and reproducible quality assessment of industrially produced physical products. Moreover, it is an object of the present invention to provide a visual inspection device and a quality assessment apparatus that can be utilized in the above system. Further, it is an object of the present invention to provide a quality assessment method and a computer program product that allow for an objective and reproducible quality assessment. Furthermore, it is an object of the present invention to provide an assessment model training apparatus, method and computer program product that allow for training an assessment model that can be utilized in the above system and method.

In a first aspect of the present invention, a quality assessment system for assessing the quality of a physical product by visual inspection is presented, wherein the system comprises a) a visual inspection device for providing visual image data of the physical product, wherein the visual inspection device comprises i) a lighting setup comprising a lighting device adapted for lighting the physical product with a predetermined lighting spectrum and a predetermined lighting angle, and ii) a camera adapted for detecting light from the lighting device after the light has interacted with the physical product and further adapted to generate visual image data of the physical product based on the detected light, and b) a quality assessment apparatus for assessing the quality of the physical product, wherein the quality assessment apparatus comprises i) an assessment model providing unit adapted to provide a trained machine learning based assessment model, wherein the trained assessment model has been trained based on historical visual image data corresponding to a physical product similar to the current physical product with a known quality, and wherein the trained assessment model is adapted to determine, based on provided visual image data of a physical product, a quality of the physical product, and ii) an assessment unit adapted to assess a quality of the physical product by applying the trained assessment model to the visual image data.

Since the visual inspection device is configured to provide visual image data of the physical product in a predetermined reproducible manner and since the quality assessment apparatus is adapted to utilize the visual image data as input for a trained machine learning based assessment model, the quality of the physical product can be assessed in a reproducible and objective manner. Generally, this allows to improve the quality assessment for a physical product.

The quality assessment system is adapted for assessing the quality of a physical product, i.e. a physical object, by visual inspection. In particular, the physical product can refer to any product that allows to at least partially assess its quality by utilizing visual means, for instance, by utilizing light reflected, scattered or shone through the physical product. In a preferred embodiment, the physical product comprises a surface with repeating regular structures, wherein the quality assessment is indicative of whether these structures have been formed as intended. In a preferred embodiment, the quality assessment can refer to assessing a topology, i.e. a surface structure, of the physical product, preferably, the topology of a foam product. Moreover, the quality assessment can also refer to a defect detection or a homogeneity measurement of at least parts of the physical product. Furthermore, in an embodiment, the product can be a foam and the quality assessment can refer to a foam micro-structure defect detection and/or analysis. Additionally or alternatively, when the product is a foam the quality assessment can refer to a porosity analysis determining, for instance, a pore structure and/or distribution via a statistical analysis.

Generally, the quality assessment system can be regarded as comprising two parts, wherein the first part refers to the visual inspection device and the second part refers to the quality assessment apparatus that refers to a computer implemented part of the system. In the quality assessment system both parts are configured to work together to produce the above-mentioned effect. However, also each part alone can be advantageously used to improve a quality assessment of a physical product.

The visual inspection device is adapted to provide visual image data of the physical product. In particular, the visual inspection device comprises a lighting setup comprising at least one lighting device. The at least one lighting device is adapted for lighting the physical product with lighting settings, like a predetermined lighting spectrum and a predetermined lighting angle. In particular, it is preferred that the lighting device lights the physical product always with the same predetermined lighting spectrum and the same predetermined lighting angle. However, in some embodiments the predetermined lighting spectrum and the predetermined lighting angle can depend on the respective physical product for which visual image data shall be provided. For example, if an industrial plant utilizing the quality assessment system is adapted to produce different physical products, the lighting device can be adapted to provide different lighting spectra and different lighting angles depending on which physical product is provided to the visual inspection device. For example, the visual inspection device can be adapted to provide identification means that allow for an identification of the specific physical product placed within the visual inspection device and to adapt the lighting setup, in particular, the lighting device, based on the identification of the physical product. For example, the physical product can be identified by a provided bar code on the physical product, by a provided RFID tag attached to the physical product, by a visual scan of the physical product or even simply by an input of a user. The identification means of the visual inspection device can then be configured accordingly. A respective assignment of the configuration of the lighting device with respect to a specific identified product, for instance, a stored respective table, can then be utilized by the visual inspection device to configure the lighting device for the identified physical product.

In a preferred embodiment, the predetermined lighting spectrum and predetermined lighting angle can be predetermined by utilizing the assessment model training apparatus for training the machine learning based assessment model. In particular, the assessment model training apparatus can comprise a hyper-parameter training unit adapted to determine based on the training of the assessment model also parameters not directly linked to the assessment model itself. In this case, the lighting setting can be determined as hyper-parameters concurrently with the training of the assessment model based on the training data. In this case the training data can be provided at different lighting settings and the hyper-parameter training unit can be adapted to determine during the training the optimal lighting settings.

Generally, the predetermined lighting spectrum provided to the physical product lies preferably in the visual range, i.e. in a wavelength range between 380 to 750 nm. However, for some applications, for instance, for a specific physical product, the predetermined lighting spectrum for the physical product can also lie, for instance, in an ultraviolet wavelength range or in an infrared wavelength range. Preferably, the predetermined lighting spectrum refers to the lighting spectrum provided by generally known lighting systems, for instance, generally known lighting devices normally utilized for lighting a room or, for instance, lighting devices used in photography applications. However, based on the physical product also a very specific and narrow lighting spectrum can be utilized.

Generally, the lighting angle can be defined as the angle provided between the lighting device, a central point of the physical product and the camera. For instance, a lighting angle of 45° refers to an angle between the line of sight of the camera to the physical product and a line of sight of the lighting device to the physical product of 45°. The predetermined lighting angle can be chosen such that it allows for a good visibility of the surface characteristics of the physical product. For example, if the quality assessment shall be focused on a topology of a surface of the physical product, the predetermined lighting angle can be adapted such that the topology becomes visible in the camera. Moreover, the predetermined lighting angle can be chosen based on whether the camera shall mainly detect light reflected from the physical product, light scattered from the physical product or light shining through the physical product.

The camera is then adapted to detect the light from the lighting device after the light has interacted with the physical product. As already described above, the interaction can refer, for instance, to a reflection, scattering or shining through the physical product depending on the lighting angle. The camera can refer to any known camera system that is adapted to detect light in the lighting spectrum provided by the lighting device or, in specific cases, of the lighting spectrum of the light after having interacted with the physical product. For example, if only specific wavelengths are reflected, scattered or shone through the physical product, the camera can be adapted to only detect these specific wavelengths. However, the camera can also be adapted to detect generally light in all wavelengths of the visible spectrum. Depending on the physical product and the provided lighting spectrum of the lighting device, the camera can also be adapted to detect infrared or ultraviolet light.

The camera is further adapted to generate visual image data of the physical product based on the detected light. In particular, generally known techniques for transducing detected light into digital data can be utilized. Generally, the visual image data can be regarded as being indicative of a respective visual image of the physical product as detected by the camera. The visual image data can then be provided in any known image data format, for instance, as raw data, jpeg, tif, bitmap, etc. Generally, the visual image data can be regarded as providing an image data point referring to an intensity and wavelength of detected light for each pixel of the visual image represented by the visual image data

The quality assessment apparatus is adapted for assessing the quality of the physical product, in particular by utilizing the visual image data provided by the visual inspection device. Generally, the quality assessment apparatus can be realized as any general or dedicated hard- and/or software. Moreover, the quality assessment apparatus can be provided in form of a dedicated apparatus, for instance, a dedicated computer that is utilized only for the task of the quality assessment. However, the quality assessment apparatus can also be realized as part of any computing system that is also used for other tasks, in particular, the quality assessment apparatus can also be regarded as being part of a distributed computing system, for instance, of cloud computing distributing the computational steps of the quality assessment apparatus to different servers.

The quality assessment apparatus comprises an assessment model providing unit. The assessment model providing unit is adapted to provide a trained machine learning based assessment model. For example, the assessment model providing unit can refer to a storage unit on which the trained machine learning based assessment model is stored. However, the assessment model providing unit can also be adapted to access a storage unit in which the trained machine learning based model is stored to receive the trained assessment model and to provide the received trained assessment model. The storage unit can, for instance, refer to a local storage unit, but also to an external storage unit, like a cloud storage.

The trained assessment model is adapted to determine based on the provided visual image data of a physical product, a quality of the physical product. In particular, the trained assessment model has been trained based on historical visual data corresponding to a physical product similar to the current physical product with a known quality. For example, visual image data acquired in the past, i.e. historical visual image data, with respect to the same kind of physical product as the current physical product and which has been assessed with respect to the quality of the respective physical products by a trained specialist can be utilized for training the assessment model. For example, if the physical product refers to the sole of a footwear, visual data acquired with the visual inspection device can be utilized as training data. This visual data can be inspected by a specialist to determine the quality of the sole to which respective visual data refers. Thus, a data set comprising tuples of historical visual data with corresponding known quality can be provided as input to the assessment model for training the assessment model. Based on the respective training, the trained assessment model is then adapted to assess a quality of a sole of footwear based on the input of respective visual data of the sole. In particular, it is preferred that the training visual data has been acquired under the same circumstances, for instance, the same lighting spectrum and the same predetermined lighting angle, as utilized during the assessment of a current physical product.

Since the quality assessment system can be used for a plurality of different physical products, the assessment model providing unit can be adapted to provide a respective trained machine learning based assessment model that is specifically adapted to assess the quality of a respective specific product. Thus, different trained machine learning based assessment models for different physical products can be stored on a storage and the assessment model providing unit can be adapted to provide the trained machine learning based assessment model corresponding to the currently assessed physical product. For example, the assessment model providing unit can utilize an identification of the physical product provided by the visual inspection device. However, the quality assessment apparatus, for instance, the assessment model providing unit, can be adapted to utilize the visual data received from the visual inspection device to identify the respective physical product. For example, an identification of the physical product can be provided as part of the visual image data, for instance, as overhead in the visual image data, as name of the visual image data, etc. However, the identity of the physical product can also be determined, for instance, using known object recognition algorithms applied to the visual image data. The assessment model providing unit can then utilize this identification to provide the corresponding trained assessment model.

Generally, the trained assessment model can refer to any known machine learning based algorithm. For example, the trained assessment model can refer to a neural network, a Bayesian classifier, an instance based algorithm, etc. Preferably, the assessment model refers to a convolutional neural network algorithm. Generally, the structural parameters of the convolutional neural network, for instance, the number of convolutional layers, filters, and/or kernel sizes can be predetermined. However, in a preferred embodiment these structural parameters are considered as hyper-parameters. In this case, the hyper-parameter training unit of the assessment model training apparatus can be adapted to determine the structural parameters concurrently with training the assessment model itself. Generally, it is preferred that the number of convolutional layers lies between 2 and 10, the filter size lies between 16 to 128, and the kernel size lies between 3 to 5. In an embodiment, the determination of the hyper-parameters leads to an optimization at two convolutional layers with a filter size of 32 followed by a further convolutional layer with a filter size of 64 and a kernel size of three for all convolutional layers. In a preferred embodiment, each convolutional layer is followed by a batch normalization layer and a dropout layer. More generally, whether or not a normalization layer and/or a dropout layer should be anywhere in the layer structure can be predetermined or also be regarded as hyper-parameters determined during the training of the assessment model. In an embodiment, the optimal structure with respect to these layers refers to a batch normalization layer after the first two layers and a dropout layer with a rate of 0.2 after all convolutional layers.

The assessment unit is then adapted to utilize the provided trained machine learning based assessment model to assess a quality of the physical product. In particular, the assessment unit is adapted to apply the trained assessment model to the visual image data by providing the visual image data as input to the trained assessment model. The trained assessment model can then provide the quality of the physical product as output. The quality provided by the assessment model can refer to a simple indication whether the quality of the physical product is sufficient for being released to a customer or not. However, the quality of the physical product can also refer to a more differentiated quality assessment, for instance, the assessment model can be adapted to provide an indication to which of at least three quality levels the physical product belongs. For example, the physical product can be sorted into a quality level referring to good quality, not good but still acceptable quality and not releasable quality. However, also more than three quality levels can be defined and the assessment model can then be trained to utilize these more than three defined quality levels. The respective determined quality of the physical product can then be provided to a supervisor of the quality assessment process, for instance, by providing the quality to a display. However, the assessed quality can also be automatically implemented into a supervisor system of the production process, and can, for instance, lead to a stop of the production if a not acceptable quality is determined, or can lead to a direct notification that the production line has to be assessed in detail to identify the problems in the production of the physical product.

In an embodiment, the quality assessment apparatus further comprises a visual image data preparation unit adapted to prepare the visual image data, wherein the preparation of the visual image data comprises segmenting the visual image data into visual image data parts, wherein a visual image data part comprises a coherent part of the visual image data, and wherein the assessment unit is adapted to assess the quality of the physical product based on applying the trained assessment model to the visual image data parts individually. A coherent part of the visual image data refers to a part of the image data that corresponds to a plurality of neighbouring pixels of the image to which the visual image data refers. For example, the visual image data preparation unit can be adapted to prepare the visual image data by dividing the corresponding image into a predetermined number of squares comprising a respective predetermined number of pixels of the image, wherein each of the squares then corresponds to a coherent part of the visual image data. However, the visual image data preparation unit can also prepare the visual image data by dividing the corresponding image in any other sensible manner, for instance, by using rectangles or other structures. Preferably, the visual image data preparation unit is adapted to prepare the visual image data such that each visual image data point, i.e. each pixel of the corresponding image, is segmented into one visual image data part. However, in other embodiments, the visual image data preparation unit can also be adapted to prepare the visual image data such that, for instance, some of the visual image data points, i.e. pixels of the corresponding image, can belong to more than one visual image data part. Moreover, in some embodiments it may be advantageous to only segment a part of the visual image data into visual image data parts such that at least some of the visual image data points, i.e. pixels of the corresponding image, do not belong to a visual image data part. Such an embodiment can, for instance, be advantageous if the quality assessment shall be focused on specific regions of the visual image data or if for the quality assessment assessing only a random sample of regions of the visual image data is sufficient.

Generally, the visual image data preparation unit can also be adapted to prepare the visual image data in other ways. For example, the visual image data preparation unit can be adapted to filter the visual image data, to increase a contrast, to decrease noise, etc. to increase the visibility of predetermined structures in the corresponding image.

The assessment unit is then adapted to assess the quality of the physical product based on applying the trained assessment model to the visual image data parts individually. In particular, the quality of each visual image data part is assessed by applying the trained assessment model. For example, a respective visual image data part can be provided as input to the trained assessment model and the trained assessment model can provide as output a quality for this visual image data part. For this assessment, the trained assessment model has not necessarily to be trained for each visual image data part individually. In particular, if a physical product with repeating regular structures, like a foam plate, shall be assessed, the same trained assessment model can be applied to each visual image data part. However, in embodiments in which the visual image data parts comprise strongly differing characteristics, for instance, since the physical product comprises differing characteristics in different parts, for instance, different surface structures in different parts, it is preferred that differently trained assessment models are provided for each of the differing visual image data parts. For example, an assessment model can be trained for each of the differing visual image data parts by preparing the respective training historical visual image data in the same way as the current visual image data and training an assessment model only with the respective historical visual image data parts to which the trained assessment model shall later be applied. The different trained assessment models can then be stored, for instance, together with an identification that indicates to which visual image data parts the respective trained assessment model is applicable. The assessment model providing unit can then be adapted to select for each visual image data part the respective corresponding trained assessment model for providing the same such that the assessment unit can apply the provided trained assessment model to the respective visual image data parts. The assessment unit can then be adapted to provide the qualities determined for each visual image data part individually as quality of the physical product. For example, the assessment unit can be adapted to provide the qualities as quality map showing the quality of each visual image data part overlying a corresponding image, for instance, in different colors. Thus, a supervisor of the system can directly see on the quality map which parts of the product have which quality.

In a preferred embodiment, the applying of the trained assessment model to the visual image data parts individually comprises determining, utilizing the trained assessment model, for a visual image data part a part quality independently of a part quality of other visual image data parts, wherein the assessment unit is adapted to determine the quality of the physical product as an overall quality based on the determined part qualities of the visual image data parts. For example, the assessment unit can be adapted to apply simple rules for determining the overall quality based on the part qualities. For example, a simple rule can be that if a predetermined amount of part qualities indicates a low quality of the physical object, the overall quality is determined as being low. However, a simple rule can also be that if at least one part quality indicates a non-acceptable quality of a part of the physical product, the overall quality also refers to a non-acceptable quality. However, the overall quality can also be determined, for instance, as an average of the part qualities or as a weighted average of the part qualities. For example, some parts of the physical products can be weighted with a higher weight than other parts, for instance, due to the knowledge that these parts of the physical product reflected by some visual image data parts are more important for the overall functioning of the product.

In a preferred embodiment, the assessment model providing unit is further adapted to provide a trained machine learning based overall quality determinator, wherein the trained overall quality determinator is adapted to determine as quality of a physical product an overall quality based on part qualities determined for segmented visual image data parts, wherein the assessment unit is adapted to apply the overall quality determinator to the part qualities of the visual image data parts to determine the quality of the physical product. The overall quality determinator can be based on any known machine learning algorithm, for example, on a neural network, a Bayesian classifier, a decision network, etc. In a preferred embodiment, the overall quality determinator is based on a Gaussian process classifier comprising classifier parameters, wherein the training of the overall quality determinator comprises tuning the classifier parameters such that the overall quality determinator is adapted to determine, as quality of a physical product, an overall quality based on part qualities determined for segmented visual image data parts. Preferably, the overall quality determinator is trained by providing historical part qualities, determined, for instance, from the historical visual image data used for training the trained assessment model and by providing a corresponding known overall quality for each historical visual image data. For instance, the overall quality for a set of part qualities can be known from a quality check of the corresponding physical product performed by a trained human specialist in past assessments of physical products. The historical part qualities and corresponding overall qualities can then be provided as training input to the classifier, wherein the training comprises the tuning of the classifier parameters such that when provided with the historical part qualities the classifier outputs the corresponding overall quality. After this training process, the trained classifier is then adapted to determine based on the part qualities of current visual image data the overall quality of a current physical product.

In an embodiment, the lighting setup comprises at least two lighting modes, wherein a lighting mode differs from another lighting mode by providing a differing lighting setting, wherein the camera is adapted to generate visual image data for the at least two lighting modes, and wherein the assessment unit is adapted to assess the quality of the physical product by applying the assessment model to the visual image data generated for the at least two lighting modes. The differing lighting settings can refer, for instance, to applying light with different predetermined spectra and/or from different predetermined lighting angles. For example, in one lighting mode light with a first lighting spectrum can be provided at a first lighting angle and at a different lighting mode light with a second lighting spectrum and a second lighting angle can be provided to the physical product, wherein the camera is then adapted to generate visual image data of the physical product for each lighting mode. In a preferred embodiment, the lighting setup is adapted such that the at least two lighting modes can be provided to the physical product at the same time, for instance, by providing a lighting device providing the respective spectrum and the respective lighting angle for each of the different lighting modes. However, the lighting setup can also be adapted such that the different lighting modes are provided subsequently, for instance, by controlling lighting devices such that first a lighting device corresponding to a first lighting mode provides light to the physical object and then a lighting device corresponding to a different lighting mode provides light to the physical object, etc. Moreover, in this embodiment the lighting setup can also be adapted such that one lighting device provides the light for the different lighting modes. For example, the one lighting device can be configured to provide a different light spectrum for different lighting modes and/or to provide light from different lighting angles for different lighting modes.

The assessment unit is then adapted to assess the quality of the physical product by applying the assessment model to the visual image data generated for the at least two lighting modes. For example, any of the above described embodiments for assessing the quality, for instance, as overall quality, can also be utilized by the assessment model based on the at least two visual image data generated for the respective lighting modes. For example, the above described embodiments for assessing the quality of the physical product can be applied to each of the at least two visual image data individually, for instance, utilizing respectively differently trained assessment models and optionally respectively differently trained overall quality determinators. In this case, the result of the quality assessment can refer to at least two quality indicators that indicate the quality of the physical product. These at least two quality indicators can then be regarded as being indicative of the quality of the physical product and can, for instance, be provided to a user of the system. However, the assessment unit can also be adapted, in this case, to determine an overall quality based on the two respective quality indicators, for instance, by averaging the quality indicators determined for each of the visual image data or by applying other rules to the quality indicators of each of the visual image data. However, in a preferred embodiment, the trained assessment model is adapted to assess, based on at least two visual image data of the physical product generated for two different lighting modes as input, the quality of the physical product. In particular, in this embodiment the trained assessment model is trained to utilize directly the at least two visual image data as input or optionally corresponding at least two visual image data parts of the at least two visual image data as input to determine the quality of the physical product. This allows to directly assess, for instance, different aspects of the physical product that are respectively highlighted by the at least two lighting modes for the assessment of the quality of the physical product.

In a further aspect, a visual inspection device for providing visual image data of a physical product is presented, wherein the visual inspection device comprises i) a lighting setup comprising a lighting device adapted for lighting the physical product with a predetermined lighting spectrum and a predetermined lighting angle, and ii) a camera adapted for detecting light from the lighting device after the light has interacted with the physical product and further adapted to generate visual image data of the physical product based on the detected light.

In a further aspect, a quality assessment apparatus for assessing a quality of a physical product is presented, wherein the quality assessment apparatus comprises i) a visual image data providing unit adapted to provide visual image data corresponding to an image of the physical product, ii) an assessment model providing unit adapted to provide a trained machine learning based assessment model, wherein the trained assessment model has been trained based on historical visual data corresponding to a physical product similar to the current physical product with a known quality, and wherein the trained assessment model is adapted to determine, based on provided visual image data of a physical product, a quality of the physical product, and iii) an assessment unit adapted to assess a quality of the physical product by applying the trained assessment model to the visual image data. In particular, the visual image data providing unit can be adapted to provide visual image data of the physical product that has been generated by a camera of a visual inspection device as described above. However, the visual image data can also be provided by other imaging means, wherein the assessment model in such a case can be trained based on historical image data provided by these other imaging means. The visual image data can, for instance, be stored on a storage, wherein the visual image data providing unit can be adapted to retrieve the visual image data from the storage for providing the same. However, the visual image data providing unit can also be directly connected to an imaging means, for instance, the visual inspection device, for receiving the visual image data from the imaging means and for providing received visual image data. Moreover, if the quality assessment apparatus is directly provided within a system together with the imaging means, for instance, the visual inspection device as defined in the system described above, the visual image data providing unit can also be omitted, since the visual image data can already be regarded as being provided by the imaging means.

In a further aspect of the invention, an assessment model training apparatus for training a machine learning based assessment model is presented, wherein the training apparatus comprises i) a visual image data providing unit adapted to provide historical visual image data of physical products with a known quality, ii) an assessment model providing unit adapted to provide a trainable assessment model that is to be trained by utilizing machine learning, iii) a training unit adapted to train the provided assessment model based on the provided historical visual image data and corresponding quality such that the trained assessment model is adapted to determine the quality of a physical product based on visual image data of the physical product.

In a preferred embodiment, the training apparatus further comprises a feedback providing unit adapted to provide feedback of a user on an assessed quality of a physical product determined by the trained assessment model, wherein the training unit is adapted to train the assessment model further based on the feedback. The feedback can refer, for instance, to a correction of the quality assessed by the assessment model indicating that for the respective physical product the assessment of the trained assessment model was not correct. The training unit is then adapted to utilize the corrected quality and the corresponding visual image data for again training the assessment model such that when applying the retrained assessment model to the respective visual image data the correct quality is provided as output. The respectively retrained assessment model can then be utilized by the quality assessment apparatus in the future.

In a preferred embodiment, the assessment model training apparatus comprises a hyper-parameter training unit adapted to determine, based on the training of the assessment model, hyper-parameters that refer to parameters other than the training parameters of the assessment model. For instance, the hyper-parameters can refer to the lighting settings or to the structural parameters of the assessment model. Generally, the hyper-parameters can be determined concurrently with the training of the assessment model, for instance, based on the training data and/or based on the results of the training of the assessment model. For example, the training data can be provided for different lighting settings and the hyper-parameter training unit can be adapted to determine, during the training of the assessment model, whether one or more of the lighting settings leads to better results in the training of the assessment model, wherein then these lighting settings can be determined as optimal lighting settings used as predetermined lighting settings. Additionally or alternatively, the hyper-parameters can comprise the structural parameters of the assessment model itself, for instance the number of convolutional layers, filters, kernel sizes and/or whether or not to provide batch normalization layers and/or dropout layers. These parameters can then be trained concurrently with the general parameters of the assessment model.

In a further aspect of the invention, an overall quality determinator training apparatus for training a machine learning based overall quality determinator is presented, wherein the training apparatus comprises i) a part quality providing unit adapted to provide historical part qualities of physical products with a known overall quality, ii) an overall quality determinator providing unit adapted to provide a trainable overall quality determinator that is to be trained by utilizing machine learning, and iii) a training unit adapted to train the provided overall quality determinator based on the provided historical part qualities and the corresponding overall qualities by adapting the parameters of the overall quality determinator such that the trained overall quality determinator is adapted to determine the overall quality of a physical product based on provided part qualities of the physical product.

In a further aspect of the invention, a quality assessment method for assessing a quality of a physical product is presented, wherein the quality assessment method comprises i) providing visual image data corresponding to an image of the physical product, ii) providing a trained machine learning based assessment model, wherein the trained assessment model has been trained based on historical visual data corresponding to a physical product similar to the current physical product with a known quality, and wherein the trained assessment model is adapted to determine, based on provided visual image data of a physical product, a quality of the physical product, and iii) assessing a quality of the physical product by applying the trained assessment model to the visual image data.

In a further aspect of the invention, an assessment model training method for training a machine learning based assessment model is presented, wherein the training method comprises i) providing historical visual image data of physical products with a known quality, ii) providing a trainable assessment model that is to be trained by utilizing machine learning, iii) training the provided assessment model based on the provided historical visual image data and corresponding quality such that the trained assessment model is adapted to determine the quality of a physical product based on visual image data of the physical product. Optionally, the providing of the historical visual image data of physical products with a known quality can also refer to providing historical visual image data parts of physical objects with a known part quality, for instance, for training the assessment model with respect to the above described embodiment comprising the segmentation of the visual image data into visual image data parts.

In a further aspect, an overall quality determinator training method for training a machine learning based overall quality determinator is presented, wherein the training method comprises i) providing historical part qualities of physical products with a known overall quality, ii) providing a trainable overall quality determinator that is to be trained by utilizing machine learning, and iii) training the provided overall quality determinator based on the provided historical part qualities and the corresponding known overall qualities by adapting the parameters of the overall quality determinator such that the trained overall quality determinator is adapted to determine the overall quality of a physical product based on provided part qualities of the physical product.

In a further aspect, a computer program product is presented, wherein the computer program product comprises program code means for causing the quality assessment apparatus as described above to execute the quality assessment method as described above.

In a further aspect, a computer program product is presented wherein the computer program product comprises program code means for causing the assessment model training apparatus as described above to execute the assessment model training method as described above.

In a further aspect, a computer program product is presented wherein the computer program product comprises program code means for causing the overall quality determinator training apparatus as described above to execute the overall quality determinator training method as described above.

It shall be understood that the system as described above, the apparatuses as described above, the methods as described above and the computer program products as described above have similar and/or identical preferred embodiments, in particular, as defined in the dependent claims.

It shall be understood that a preferred embodiment of the present invention can also be any combination of the dependent claims or above embodiments with the respective independent claim.

These and other aspects of the present invention will be apparent from and elucidated with reference to the embodiments described hereinafter.

### BRIEF DESCRIPTION OF THE DRAWINGS

In the following drawings:

FIG. 1 shows schematically and exemplarily an embodiment of a quality assessment system for assessing the quality of a physical product,

FIG. 2 shows schematically and exemplarily an embodiment of an assessment model training apparatus,

FIG. 3 shows a flow chart exemplarily illustrating an embodiment of a method for assessing a quality of a physical product,

FIG. 4 shows a flow chart exemplarily illustrating an embodiment of a method for training a quality assessment model,

FIG. 5 shows an example for quality levels of an exemplary physical product,

FIG. 6 shows schematically and exemplarily a more detailed realization of a visual inspection device,

FIG. 7 shows exemplary visual image data acquired with the example of the visual inspection device for an exemplary physical product,

FIG. 8 shows schematically and exemplarily a preparation of visual image data of an exemplary physical product,

FIG. 9 shows schematically and exemplarily principles of applying an overall quality determinator, and

FIG. 10 shows schematically and exemplarily an implementation of a feedback into a training of an assessment quality model.

### DETAILED DESCRIPTION OF EMBODIMENTS

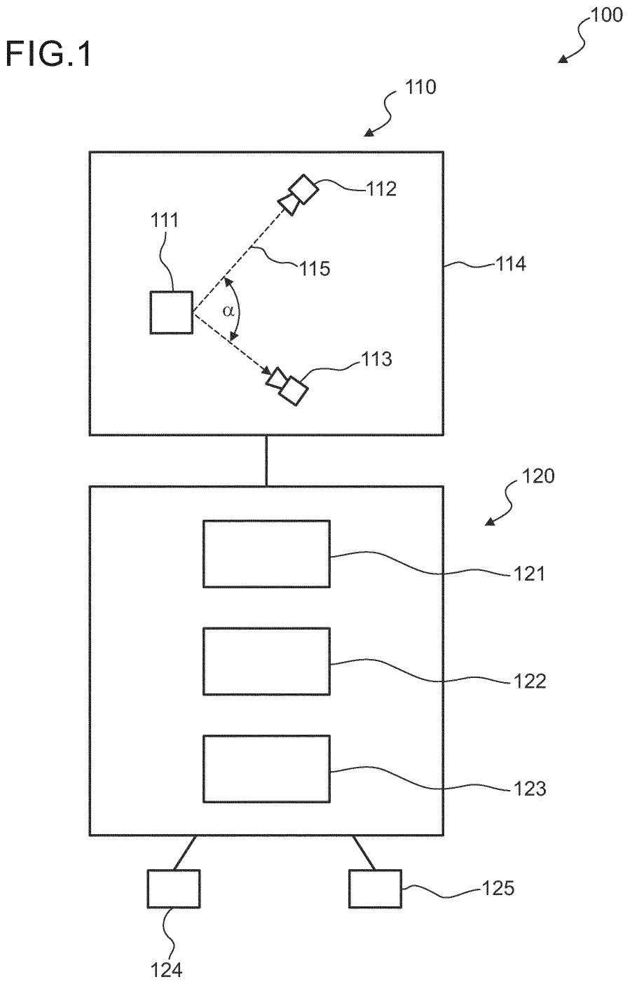

FIG. 1 shows schematically and exemplarily an embodiment of a quality assessment system 100 for assessing the quality of a physical product 111 by visual inspection. The system 100 comprises a visual inspection device 110 and a quality assessment apparatus 120. In this exemplary embodiment, the physical product 111 is placed within a box 114 of the visual inspection device 110. The box 114 is in this example adapted to shield the physical product 111 from light coming from outside of the box 114. This ensures that the images, i.e. the visual image data, of the physical product 111 is acquired always under the same conditions. The physical product 111 can refer to any physical product that allows for a quality assessment by visual inspection. However, it is preferred that the physical product comprises a surface with repeating regular structures, wherein the quality is assessed based on the characteristics of the repeating regular structure. In later examples, the physical product can refer to a foam comprising such a repeating regular structure.

The visual inspection device 110 is adapted to provide visual image data of the physical product 111. In particular, the visual inspection device 110 comprises a lighting setup comprising a lighting device 112 that is adapted to light the physical product 111. Preferably, the lighting device 112 lights the physical product 111 with a predetermined lighting spectrum and under a predetermined lighting angle α. Generally, the lighting angle α can be defined as the angle under which the light from the lighting device 112 is reflected, scattered or transmitted by the physical object 111 and travels to the camera 113 of the visual inspection device 110. The camera 113 is adapted to detect the scattered, reflected or transmitted light 115 of the lighting device 112. For example, the camera 113 can be any generally known camera system that allows to detect light of the predetermined lighting spectrum and to generate visual image data based on the detected light, wherein the visual image data corresponds to an image of the physical product 111 under the respective lighting conditions. The camera 113 is then adapted to provide the generated visual image data to the quality assessment apparatus 120.

The quality assessment apparatus 120 is adapted to assess the quality of the physical product 111. In this example, the quality assessment apparatus 120 comprises an assessment model providing unit 121, optionally a visual image data preparation unit 122, and an assessment unit 123. Further, the quality assessment apparatus 120 comprises preferably an input unit 124, like a keyboard, a mouse, a touchscreen, etc., and an output unit 125, like a display, a light, an audio speaker, etc.

The assessment model providing unit 121 is adapted to provide a trained machine learning based assessment model. Generally, the assessment model can refer to any known machine learning based model that is suitable for identifying and processing respective structures in the provided visual image data for applying a respective quality level to the provided visual image data. Preferably, the assessment model is based on a convoluted neural network algorithm. The trained assessment model can be stored, for instance, on a storage unit not shown in FIG. 1 on which, for instance, a plurality of assessment models can be stored that can be utilized under different circumstances. For example, for different physical products 111 different assessment models can be provided. Moreover, also for different parts of the visual image data different assessment models can be provided. Further, if more than one image is provided by the visual inspection device 110, for instance, by generating visual image data at different lighting spectra and/or lighting angles of the physical product 111, also for each of these different visual image data of the product 111 a different assessment model can be provided and stored on the respective storage unit. The assessment model providing unit 121 can then be adapted, for instance, to access the storage unit, and select a respective suitable trained assessment model, for instance, by utilizing an identity, a lookup table, or some other correlation of a respective assessment model with the provided visual image data.

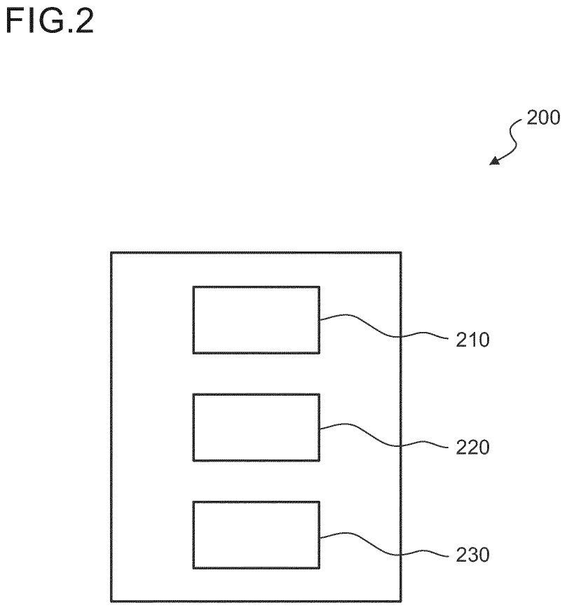

The respective trained assessment model has been trained such that it is adapted to determine based on the provided visual image data of the physical product 111 a quality of the physical product 111. For example, the trained assessment model can be trained utilizing assessment model training apparatus 200 as schematically and exemplarily shown in FIG. 2. Assessment model training apparatus 200 comprises a visual image data providing unit 210, an assessment model providing unit 220 and a training unit 230.

The visual image data providing unit 210 is adapted, for instance, to provide training visual image data which preferably refers to historical visual image data of one or more physical product of a kind for which the assessment model shall be trained. For example, if the assessment model shall be trained for identifying the quality of a structure provided on the surface of a foam, the historical visual image data refers to images of such a foam comprising structures with different qualities. In particular, for each provided historical visual image data, the quality of the corresponding physical product is known. For example, a human expert or specialist may be utilized to determine a respective quality for each of the physical products corresponding to the historical visual image data. Thus, the training data provided by the visual image data providing unit 210 comprises generally for a plurality of physical products historical visual image data and a corresponding known quality.

Further, the assessment model providing unit 220 is adapted to provide a trainable assessment model that shall be trained by utilizing machine learning. For instance, the assessment model providing unit 220 can provide a convoluted neural network with arbitrary neural network parameters as a starting point for the training. However, the provided assessment model can also refer to an already at least partially trained assessment model that shall, for instance, be retrained based on newer or additional input. For example, such a newer or additional input can be part of a feedback provided by a user utilizing the quality assessment system 100 and noting that a quality for at least one physical product has not been determined correctly. In this case, the visual image data together with the correct quality determination can be provided as feedback by the user and can be utilized for retraining an already trained assessment model.

The training unit 230 is then adapted to train the provided assessment model by utilizing the provided historical visual image data and the corresponding quality as input to the assessment model such that after the training the assessment model is adapted to determine the quality of physical products of the same kind, for instance, with a corresponding surface structure, based on the visual image data of the physical product alone.

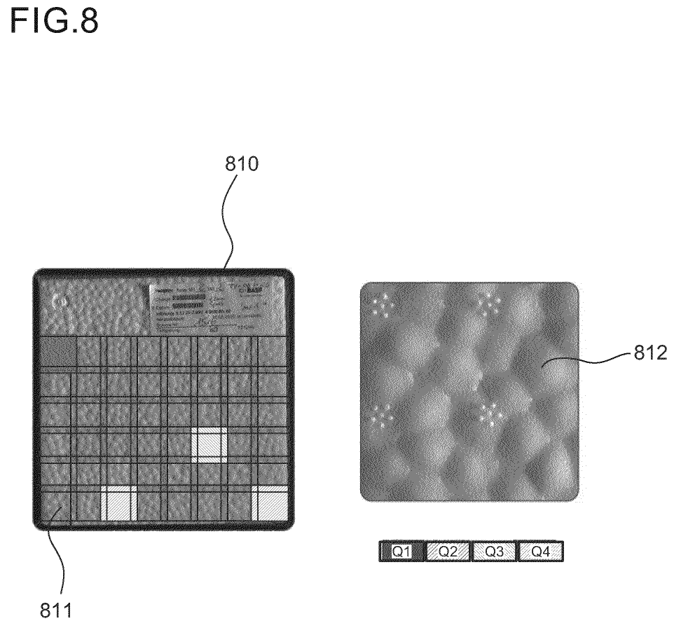

In a preferred but optional embodiment, the quality assessment apparatus 120 comprises a visual image data preparation unit 122. The visual image data preparation unit 122 is adapted to prepare the visual image data. Preferably, the preparation of the visual image data comprises segmenting the visual image data and thus also the corresponding image into visual image data parts that comprise a coherent part of the visual image data, i.e. consist of a plurality of neighboring pixels of the image corresponding to the visual image data. An example for such a preparation is given, for instance, in FIG. 8 in which the image 810 of a foam sample is segmented into a plurality of quadratic segments as visual image data parts 811. An increased view of such a segment corresponding to a visual image data part is shown in image 812. The prepared visual image data is in this optional case then provided together with the assessment model that has in this optional case also been trained based on prepared visual image data to the assessment unit 123.

The assessment unit 123 is then adapted to assess a quality of the physical product 111 by applying the trained assessment model to the prepared visual image data. In particular, in this example it is preferred that the trained assessment model is applied to the visual image data parts individually, such that for the respective visual image data parts a part quality is determined. An example for such a part quality can also be seen, for instance, in FIG. 8, where the hatching of the different parts of the image 810 indicates a level of quality ranging from Q1 perfect quality to Q4 not acceptable quality for each visual image data part 811. In one embodiment, the result for each individual visual image data part 811, i.e. the quality for each individual image data part 811, can refer to the quality outcome of the assessment unit 123. For example, an image as the image 810 shown in FIG. 8, can, in this case, be provided to a user or supervisor of the quality assessment on the output unit 125, for instance, on a display. The user can then utilize the provided quality assessment map, i.e. the quality determined for each visual image data part 811, to determine a further procedure for this product. However, in a preferred embodiment, the assessment model providing unit 121 is further adapted to provide a trained machine learning based overall quality determinator. The trained overall quality determinator can then be adapted to determine an overall quality of the physical product 111 based on the provided part qualities determined for the respective segmented visual image data parts 811.

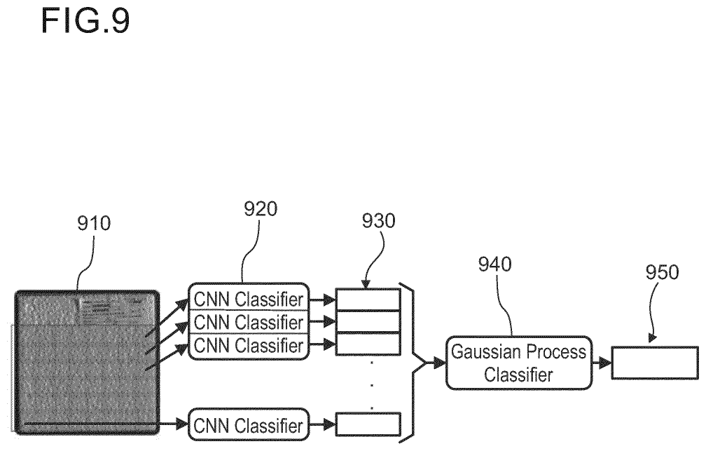

A principle of such an overall quality determinator is shown, for instance, in FIG. 9. In FIG. 9, again an image 910 corresponding to visual image data is prepared by segmenting the image data into a plurality of visual image data parts, wherein on each visual image data part an assessment model 920, for instance, a convolutional neural network classifier as indicated in FIG. 9, is applied as indicated by the arrows. The result provided by the assessment model refers to a part quality 930, for instance, a part quality indicator, for each segmented visual image data part. Each part quality 930 is then provided to the overall quality determinator 940, preferably, referring to a Gaussian process classifier as indicated in FIG. 9, wherein the overall quality determinator 940 then provides as output an overall quality 950 for the physical product. In this case, the overall quality of the physical product can then be provided to a user, for instance, using the output unit 125 like a display, for indicating the overall quality.

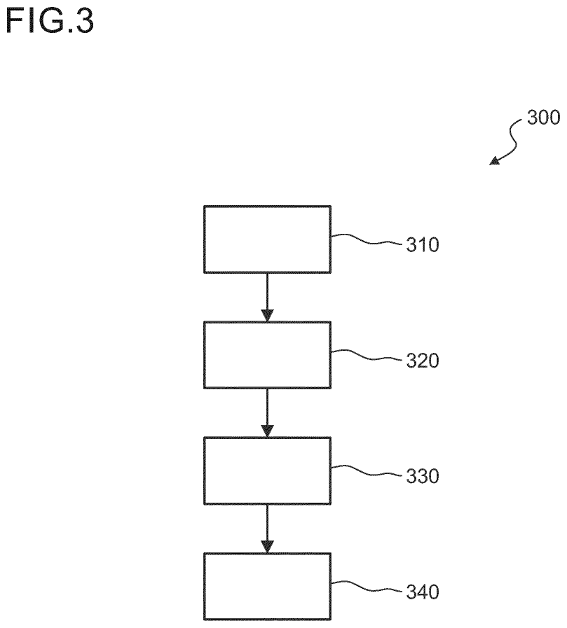

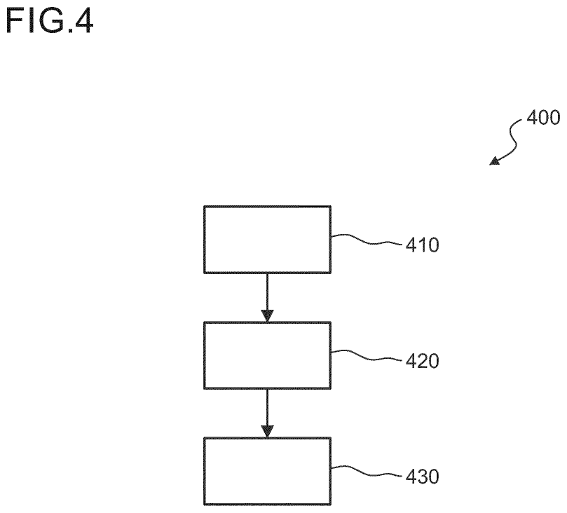

FIG. 3 shows schematically and exemplarily a flow chart of a method 300 for assessing a quality of a physical product. The quality assessment method 300 comprises in a first step 310 providing visual image data of the physical product, for instance, by receiving visual image data from visual inspection device 110. In a second step 320 a trained machine learning based assessment model is provided, in particular, in accordance with the above described principles. In particular, the trained machine learning based assessment model can be trained utilizing assessment model training method 400 shown in FIG. 4. The assessment model training method 400 comprises then a first step 410 of providing historical visual image data of physical products with a known quality, for instance, in accordance with the principles described with respect to the assessment model training apparatus shown exemplarily in FIG. 2. Further, the method 400 comprises a step 420 of providing a trainable assessment model, for instance, a convoluted neural network, that is to be trained by utilizing machine learning. The steps of providing historical visual image data 410 and providing a trainable assessment model 420 can be processed in any arbitrary order or even at the same time. The training method 400 then further comprises step 430 of training the provided assessment model based on the provided historical visual image data and corresponding qualities such that the trained assessment model is adapted to determine the quality of a physical product based on visual image data of the physical product. This trained assessment model can then, for instance, be provided in step 320 of the quality assessment method 300. Generally, the steps 310 and 320 can be performed in any arbitrary order or even at the same time. Optionally, the quality assessment method 300 can comprise the step 330 of preparing the visual image data, for instance, in accordance with the above described examples by segmenting the visual image data into a plurality of visual image data parts. The quality assessment method 300 then further comprises the step 340 of assessing a quality of the physical product by applying the trained assessment model to the visual image data or optionally the visual image data parts.

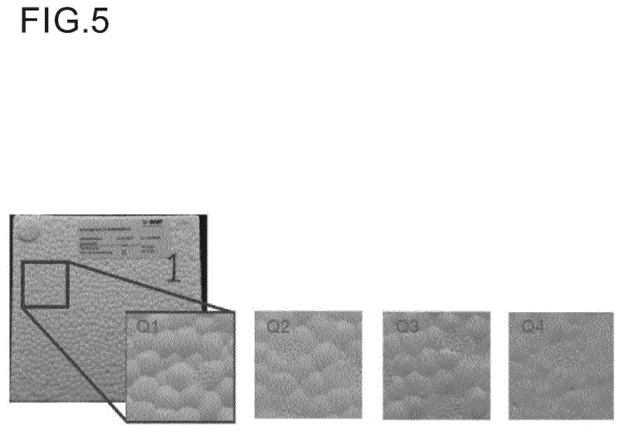

In the following, a more detailed example of a preferred embodiment of the invention will be described with respect to FIGS. 5 to 10. In particular, the embodiment refers to an AI-based solution for a fully automated visual inspection in production. Preferably, the embodiment comprises an assessment model training method that can comprise an expert in the loop algorithm that allows for a fully automated assessment model building based on user feedback. Further, it is preferred that in an embodiment the computer implemented parts of the system as described above, for instance, the quality assessment apparatus 120, are implemented as cloud architecture, for instance, by connecting hardware parts, like the visual inspection device 110 to an Azure Cloud as an Internet of Things device.

In the following an example of a preferred embodiment will be given with respect to a molded foam plate. In this example, apart from mechanical properties, the only feature that determines the quality of the molded foam plate, is its surface topology. Thus, the evaluation of the surface quality can be done by means of a human visual inspection. In this inspection different quality grades are defined in a range, as shown in FIG. 5, from Q1, i.e. perfect surface structure, to Q4, i.e. flat or defective surface and thus no release of the tested production lot. Reference plates can be used for each quality grade as a guidance for the human specialist responsible for grading a plate in order to reduce the human bias in the grading process and to ensure comparability of quality ratings between the respective production plants worldwide. However, with plurality of production plants worldwide and even more human specialists involved in the inspection and rating process, human bias in judgements cannot be precluded completely. Therefore, it would be advantageous to provide an automated inspection process for a proper recording of the plate surfaces as well as providing a corresponding grading algorithm and graphical user interface for grading the plates independent of human influence.

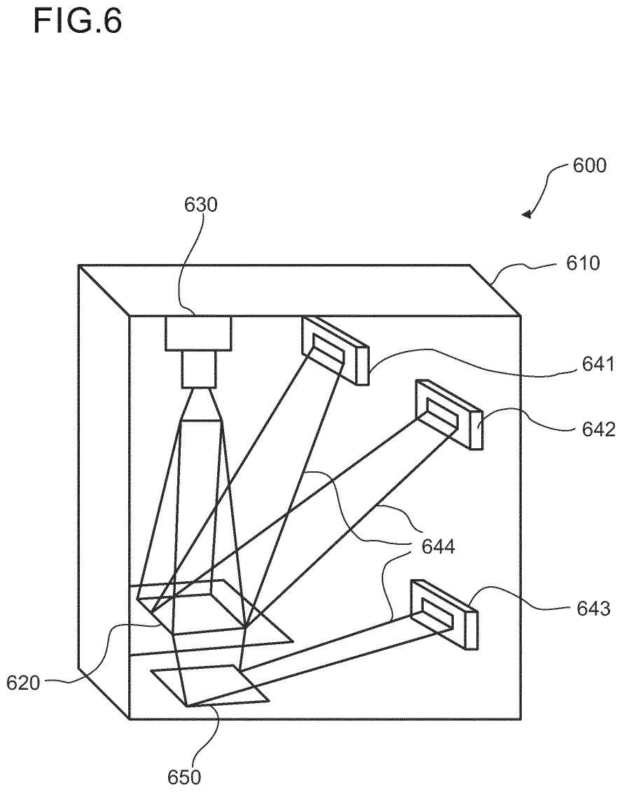

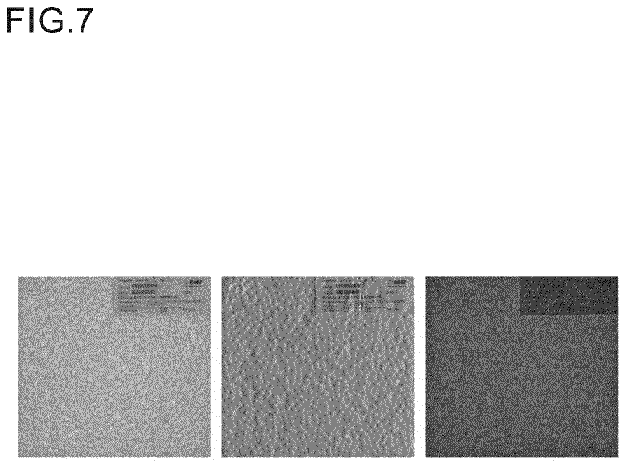

A part of this system is a visual inspection device, referring substantially to hardware that is designed to ensure reliable and reproducible image acquisition of, in this example, the test plates. Preferably, the visual inspection device 600, as shown as detailed example in FIG. 6 comprises an industrial camera 630, light devices 641, 642, 643 for providing a lighting setup and a holding fixture 620 for the test specimen. In FIG. 6 further exemplary light paths 644 for providing the light to the test specimen are shown. Moreover, it is preferred that these components are encased by a box 610 that prevents disturbances from external light sources. A sample specimen as physical product can be inserted and taken out of the box, for instance, through a small hatch. A control system of the visual inspection device can be implemented, for example, in form of a LabVIEW® application that runs on a small PC that can be integrated into the box. A touch display can be provided that can work as a human machine interface, making the visual inspection device 600 to a stand-alone device without need for supplementary hardware. Preferably, as shown on FIG. 6 three light sources 641, 642, 643, i.e. lighting devices, can be installed in the visual inspection device 600. In the preferred application for determining the quality of the structure of the above described foam plate, the lighting devices comprise a top light, providing light from a lighting angle smaller than 45°, a side light providing light from a lighting angle of approximate 45°, and a transmission light providing light such that it shines through the physical product, in this example, the foam plate. In the exemplary setup shown in FIG. 6 the transmission light is provided by reflecting the light form the lighting device 643 from mirror 650 to an underside of the foam plate on the holding fixture 620. For this case the holding fixture 620 can comprise an opening that allows the light to reach the underside of the foam plate directly, or can be configured to be transparent for at least some wavelength of the light provided by the lighting device 643. For each of these lighting settings, or lighting modes, an image can be taken that can be represented by corresponding visual image data. An example, for the three images is shown in FIG. 7. Preferably, in this example the first image acquired by using the diffused top light is used as a digital retain sample of the test foam plate.

Further, in this example, the foam plates comprise a QR code that is designed to label the plates and provide an identification of the plates, and thus of the physical product in the visual inspection device, for instance, visual inspection device 600. In this case, the visual inspection device preferably comprises identification means that are configured to scan the QR code to get information, for instance, that associates the image with product data, e.g. a lot and shot number. Thus, the read-in data can serve as a unique identifier for all images taken by the visual inspection device. Moreover, the visual inspection device can also be adapted to utilize the identification to apply the corresponding lighting setting, for example, the visual inspection device can send this data to a server to ask for a desired illumination setup, i.e. lighting setting, for the images to be taken.

Generally, all three images can be utilized for determining the quality of the foam plate alone or in combination. However, in the following for simplifying the example only the second image shown in FIG. 7 acquired by the side light is used for topology grading and thus for the quality assessment. However, for example, also the third image acquired by the transmission light can potentially be utilized and provide information on a fusing quality and internal defects of the foam plate as it visualizes the grain boundaries and inner structure of the respective test plate. Moreover, also even more images can be utilized, for instance, for determining the precise determination of color an RGB camera can be provided in the visual inspection device and the respective RGB-images can be utilized.

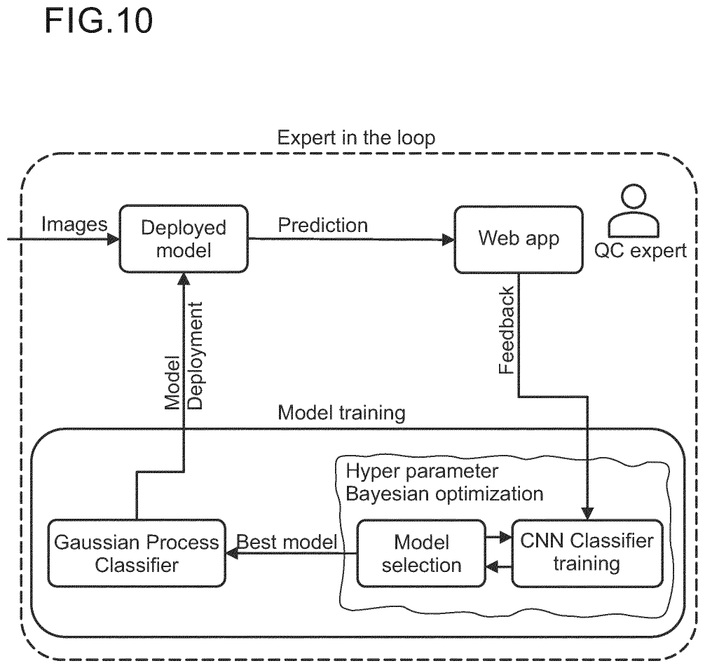

The analysis and grading, i.e. the quality assessment, of the physical product, in this example the foam plate, is then performed based on the acquired side-light image utilizing a quality assessment apparatus based, for instance, on a Convolutional Neural Network (CNN) algorithm. The quality assessment apparatus can be realized, for example, in a cloud or on a local PC. The utilized CNN can be trained, for example, with data from the visual inspection device with respect to historical quality assessments. Moreover, to ensure the quality of the assessment of the CNN an expert operator can be defined who is allowed to correct the algorithm's training, for instance, by providing respective feedback data for retraining the CNN algorithm, as shown, for instance, in FIG. 10. Based on the feedback the assessment model accuracy can be increased with time, up to a point when human intervention in form of feedback data is no longer necessary.

In a preferred embodiment, the quality assessment apparatus comprises a visual image data preparation unit that partitions the plate image, for instance, into 48 segments that are graded individually, i.e. for which a part quality is determined. In this case the mode of these individual grades can be taken as the overall plate's rating, i.e. the overall quality. Moreover, additionally a “homogeneity index” can be defined to reflect the variation of grades, i.e. part qualities, given for the individual segments, i.e. visual image data parts.

In the following, the preferred quality assessment is explained in more detail with respect to the above mentioned foam plate. However, it is noted that the algorithm is flexible and can also be adapted to other use-cases. In the following example, the objective of the quality assessment is to classify foam plates into four classes depending on their surface topology. As it shown in FIG. 5, the best quality plate has a specific 3D structure on its surface (Q1), while in the worst quality plate, the particles are melted too much and have a flat surface (Q4).

For this goal it has shown to be advantageous to follow a “two-step” approach utilizing two trainable machine learning algorithms. The first machine learning algorithm refers to the assessment model as described above and preferably is realized as a CNN classifier. In this embodiment, the images of plates, i.e. the visual image data, are initially divided into 48 segments, i.e. visual image data parts. The trained CNN classifier is then applied to each segment, i.e. visual image data part, individually and classifies each segment into one of the four classes Q1 to Q4. Preferably, the architecture of the CNN is tuned by using a Bayesian optimization in the training steps. It is noted that the architecture of the CNN itself can evolve during the training of the CNN, for instance, based on provided feedback data from human experts.

The second machine learning algorithm refers to the overall quality determinator as described above and can be realized as a Gaussian Process Classifier. As mentioned above the CNN classifier returns the grade, i.e. part quality, of the small segments of plates, i.e., it returns 48 numbers indicative of the 48 part qualities for each plate. The objective of the Gaussian process classifier is then to classify the entirety of each plate based on the outcome of the CNN classifier as, for instance, shown in FIG. 9. The parameters of the Gaussian process classifier can be tuned such that it maintains a high sensitivity and selectivity to class Q4 qualities. In fact, the high sensitivity and selectivity to class Q4 quality allows to ensure that the worst quality plates are never delivered to customers.

As stated above, the control system of the visual inspection device can be based on a data acquisition platform, like the LabVIEW® platform, the DASYLab platform, Agilent VEE platform, etc. for instrument control and automation. It can control all hardware components such as light modules and the camera. An advantageous aspect in this case is a possibility of interacting with other infrastructure such as premise data storage systems, like an R&D Data Lake, Hadoop platform, etc., and a cloud based platform, like the Azure Cloud, the AWS cloud, the GCP cloud, etc. such that information can be exchanged and centrally managed.

The on premise data storage can, for example, together with an AppStore provide all infrastructure services for the initial development of the data management along the software development infrastructure. For example, notification events that occur on the visual inspection device such as “new image is acquired” can be transmitted to the on premise data storage via a REST API, which starts to process the data triggering a taskset. As advantageous services of the on premise data storage that can be utilized, for example, metadata management can be stored in a relational database, image thumbnails and segments can be stored in a no-SQL database, and/or raw images can be stored in a distributed file storage.

Moreover, to allow for a higher robustness of the computer-implemented parts of the invention, a cloud-based solution is preferred. Generally, in a preferred embodiment the above described system is realized by providing a camera and a lighting setup comprising three lighting devices which are installed above, below and at a side of a sample holder for holding the physical product. Preferably, a respective data acquisition platform application is used for controlling the camera and illumination system, i.e. lighting setup, and provides user a user interface which display, for instance, on a touch screen monitor. For example, such a data acquisition platform application can perform the following tasks after a user initiates a quality assessment process: a) determine an identity of the physical product, for instance, by reading a barcode, and determine an illumination setup, i.e. lighting setting, for the respective physical product, for instance, by utilizing an illumination endpoint in the Azure runtime model, b) after getting the lighting setting, take the pictures, generate using the camera the visual image data and save the data in specific folder, and c) initiate an image, i.e. visual image data, upload by calling a custom module end point.

Preferably, a custom module application programming interface consisting of three endpoints in case of a cloud solution is provided. The three endpoints allow to upload locally stored image to a local storage, to create databases to store illumination setups and synchronize the database with a database in the cloud, and to provide the results of the quality assessment locally. Further, a local storage can store taken images locally until they are successfully uploaded to a cloud storage and can then the local copy can be deleted. An Internet of Things Hob can be provided to manage all Internet of Things devices used in the system and to create a secure connection between the devices and other cloud elements. A container based registry can store the images taken by the visual inspection device and be utilized to allow access to the applications of the quality assessment apparatus. For example, a cloud storage can be used to store all images and their segments and thumbnails and a PostgreSQL DB Relational database can be used for metadata.

The quality assessment apparatus can be realized at least partly, for instance, by utilizing ETL tools consist of a Data Factory and a Databricks service. For example, the Azure Data Factory can be triggered by a new image of the physical product arriving in a storage and can be adapted to initiate the Azure Databricks notebook. The Azure Databrick application can read the image and its metadata. Thereafter, the following steps can be performed: a) a thumbnail for the image is created and save in a storage, b) the image is segmented into 48 segments, i.e. image data parts, and the segmentation is saved on a storage, and c) the image metadata is stored in tables in a PostgreSQL. Thus, in this example, at least parts of the visual image data preparation unit are realized in this way.

In this example, at least parts of the quality assessment model training apparatus can be realized by utilizing a Machine Learning Service that receives the images and quality indicators for the respective images from a storage and trains a respective new quality assessment model. Respectively trained assessment models can then be saved in a container registry. The trained assessment models can then be deployed to a user, for instance, using the respective application programming interface. Moreover, for example, an InfaQtive APP can provide a user interface for showing the results of the quality assessment and check the results of the assessment. A wrongly determined quality can be labelled and the correct quality can be used to retrain the model.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the visual image data, the providing of the assessment model, the assessing of the quality, etc., performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

The invention refers to a system for assessing the quality of a physical product. A device provides visual image data of the product and comprises a) a lighting setup comprising a lighting device adapted for lighting the product and b) a camera adapted for detecting light from the lighting device to generate visual image data of the product based on the detected light. An apparatus assesses the quality of the product and comprises a) a providing unit adapted to provide a trained machine learning based assessment model, wherein the model has been trained based on historical visual image data, and wherein the trained assessment model is adapted to determine a quality of the product, and b) an assessment unit adapted to assess a quality of the product by applying the trained assessment model to the visual image data.

1. A quality assessment system for assessing the quality of a physical product by visual inspection, wherein the system comprises:
a) a visual inspection device for providing visual image data of the physical product, wherein the visual inspection device comprises:
a lighting setup comprising a lighting device adapted for lighting the physical product with a predetermined lighting spectrum and a predetermined lighting angle, and a camera adapted for detecting light from the lighting device after the light has interacted with the physical product and further adapted to generate visual image data of the physical product based on the detected light, and
b) a quality assessment apparatus for assessing the quality of the physical product, wherein the quality assessment apparatus comprises:
an assessment model providing unit adapted to provide a trained machine learning based assessment model, wherein the trained assessment model has been trained based on historical visual image data corresponding to a physical product similar to the current physical product with a known quality, and wherein the trained assessment model is adapted to determine, based on provided visual image data of a physical product, a quality of the physical product, and
an assessment unit adapted to assess a quality of the physical product by applying the trained assessment model to the visual image data.

2. The system according to claim 1, wherein the quality assessment apparatus further comprises a visual image data preparation unit adapted to prepare the visual image data, wherein the preparation of the visual image data comprises segmenting the visual image data into visual image data parts, wherein a visual image data part comprises a coherent part of the visual image data, and wherein the assessment unit is adapted to assess the quality of the physical product based on applying the trained assessment model to the visual image data parts individually.

3. The system according to claim 2, wherein the applying of the trained assessment model to the visual image data parts individually comprises determining, utilizing the trained assessment model, for a visual image data part a part quality independently of a part quality of other visual image data parts, wherein the assessment unit is adapted to determine the quality of the physical product as an overall quality based on the determined part qualities of the visual image data parts.

4. The system according to claim 3, wherein the assessment model providing unit is further adapted to provide a trained machine learning based overall quality determinator, wherein the trained overall quality determinator is adapted to determine as quality of a physical product an overall quality based on part qualities determined for segmented visual image data parts, wherein the assessment unit is adapted to apply the overall quality determinator to the part qualities of the visual image data parts to determine the quality of the physical product.

5. The system according to claim 4, wherein the overall quality determinator is based on a Gaussian process classifier comprising classifier parameters, wherein the training of the overall quality determinator comprises tuning the classifier parameters such that the overall quality determinator is adapted to determine, as quality of a physical product, an overall quality based on part qualities determined for segmented visual image data parts.

6. The system according to claim 1, wherein the lighting setup comprises at least two lighting modes, wherein a lighting mode differs from another lighting mode by providing a differing lighting setting, wherein the camera is adapted to generate visual image data for the at least two lighting modes, and wherein the assessment unit is adapted to assess the quality of the physical product by applying the assessment model to the visual image data generated for the at least two lighting modes.

7. The system according to claim 6, wherein the trained assessment model is adapted to assess, based on at least two visual image data of the physical product generated for two different lighting modes as input, the quality of the physical product.

8. A visual inspection device for providing visual image data of a physical product, wherein the visual inspection device comprises:
a lighting setup comprising a lighting device adapted for lighting the physical product with a predetermined lighting spectrum and a predetermined lighting angle, and a camera adapted for detecting light from the lighting device after the light has interacted with the physical product and further adapted to generate visual image data of the physical product based on the detected light.

9. A quality assessment apparatus for assessing a quality of a physical product, wherein the quality assessment apparatus comprises:
a visual image data providing unit adapted to provide visual image data corresponding to an image of the physical product,
an assessment model providing unit adapted to provide a trained machine learning based assessment model, wherein the trained assessment model has been trained based on historical visual data corresponding to a physical product similar to the current physical product with a known quality, and wherein the trained assessment model is adapted to determine, based on provided visual image data of a physical product, a quality of the physical product, and
an assessment unit adapted to assess a quality of the physical product by applying the trained assessment model to the visual image data.

10. An assessment model training apparatus for training a machine learning based assessment model, wherein the training apparatus comprises:
a visual image data providing unit adapted to provide historical visual image data of physical products with a known quality,
an assessment model providing unit adapted to provide a trainable assessment model that is to be trained by utilizing machine learning,
a training unit adapted to train the provided assessment model based on the provided historical visual image data and corresponding quality such that the trained assessment model is adapted to determine the quality of a physical product based on visual image data of the physical product.

11. The training apparatus according to claim 10, wherein the training apparatus further comprises a feedback providing unit adapted to provide feedback of a user on an assessed quality of a physical product determined by the trained assessment model, wherein the training unit is adapted to train the assessment model further based on the feedback.

12. A quality assessment method for assessing a quality of a physical product, wherein the quality assessment method comprises:
providing visual image data corresponding to an image of the physical product,
providing a trained machine learning based assessment model, wherein the trained assessment model has been trained based on historical visual data corresponding to a physical product similar to the current physical product with a known quality, and wherein the trained assessment model is adapted to determine, based on provided visual image data of a physical product, a quality of the physical product, and
assessing a quality of the physical product by applying the trained assessment model to the visual image data.

13. An assessment model training method for training a machine learning based assessment model, wherein the training method comprises:
providing historical visual image data of physical products with a known quality,
providing a trainable assessment model that is to be trained by utilizing machine learning,
training the provided assessment model based on the provided historical visual image data and corresponding quality such that the trained assessment model is adapted to determine the quality of a physical product based on visual image data of the physical product.

14. A computer program product for assessing a quality of a physical product, wherein the computer program product comprises program code means for causing the quality assessment apparatus of claim 9 to execute the quality assessment method according to claim 12.

15. A computer program product for training a machine learning based assessment model, wherein the computer program product comprises program code means for causing the assessment model training apparatus of claim 10 to execute the training method according to claim 13.
